(19) United States
(12) Patent Application Publication
(10) Pub. No.: US 2024/0004841 A1
(43) Pub. Date: Jan. 4, 2024

(54) METHOD FOR CONSTRUCTING GRAPH STRUCTURE OF FILE SYSTEM

(71) Applicant: Shanghai Binli Technology Co., Ltd., Shanghai (CN)

(72) Inventor: Wenyun NIU, Shanghai (CN)

(21) Appl. No.: 18/337,097

(22) Filed: Jun. 19, 2023

(30) Foreign Application Priority Data
Jul. 1, 2022 (CN) 202210766776.9

(51) Int. Cl. G06F 16/18; G06F 16/16

(52) U.S. Cl. CPC G06F 16/18; G06F 16/164

(57) ABSTRACT

A method for constructing graph structure of file system includes: a tag recording module, configured for recording corresponding relationships between files and tags; a graph structure module, configured for describing tag composition and interrelationships of nodes where a graph structure is established, wherein the tags at the nodes of the graph structure are called node tags; and a graph construction module, configured for selecting a corresponding file in the tag recording module according to the node tag in the graph structure module, and recording information of the graph structure module corresponding to the file in the tag recording module. The method of the present disclosure intuitively displays the relationships between the files and meets requirements for various structural forms of the file system and multiple file structures.

### CROSS-REFERENCE TO RELATED APPLICATIONS

The present application claims priority under Paris Convention to Chinese Patent Application No. 202210766776.9, entitled “Method for Constructing Graph Structure of File System” and filed on Jul. 1, 2022, the entirety of which is hereby incorporated by reference for all purposes as if fully set forth herein.

### TECHNICAL FIELD

The present disclosure relates to the field of computers, in particular to a construction method of a file structure of a file system.

### BACKGROUND OF THE PRESENT DISCLOSURE

In the existing file system of an operating system, structuralization of the file system serves to describe the relationship between files. At present, the widely used solution for realizing the structuralization is a directory system, that is, the files are stored in a form of a directory structure constituted of a root directory and multi-level subdirectories. This allows for file classification and hierarchical display through the directories, with all files residing within one extensive directory structure. For example, when a drive is drive C which is a root directory, all the files are under it or belong to the directories or subdirectories under it. Namely the whole file system only has one large directory. In this system, all the directories and subdirectories are equated with the files in management, so that all of them must be opened to display a complete tree file structure, which is not intuitive enough to see a subordinate relationship between the files. In addition, the relationships between files are diverse, and they may not always manifest in a hierarchical form. These relationships can take various graphical forms, highlighting the inadequacy of solely providing a directory structure with one single file structure.

In both Windows and Mac OS, tags serve the purpose of categorizing files, yet they merely facilitate expedient file retrieval, there is no structuralization solution.

Regarding non-directory file systems, such as “File System” disclosed in Chinese Patent Application No. 201911038055.0, tags are used for file classification and management. However, even in this case, file system structuralization solution is yet to be realized.

Therefore, there is a need to construct a more intuitive and diverse file system structure.

### SUMMARY OF PRESENT DISCLOSURE

In this regard, an object of embodiments of the present disclosure is to construct a graph structure of a file system, that is, to construct a graph structure with more connection relationships between files, while a directory structure is only one of forms included in the graph structure.

The specific solution is described below.

A file system for constructing a graph structure is provided. The file system includes a tag recording module, a graph structure module, and a graph construction module.

The tag recording module is configured for recording corresponding relationships between files and tags; the tag recording module includes at least one row of recording.

The graph structure module is configured for describing tag composition and interrelationships at nodes where a graph structure is established. The tags at the nodes of the graph structure are called node tags. The tag recording module is also configured for recording information of the graph structure module;

The graph construction module is configured for selecting a corresponding file in the tag recording module according to a node tag in the graph structure module, and recording the information of the graph structure module corresponding to the file in the tag recording module.

The information of the graph structure module includes module identification of the graph structure module, and location information in the graph structure module of the node tag used for selecting the file from the tag recording module.

The file in the tag recording module has a corresponding relationship with the physical address where the file is stored.

Optionally, the file system further includes a graph module.

The graph module is configured for establishing and/or displaying the graph structure including the node tags and relationships between the node tags.

The graph module has a user interface; the user interface includes a tool for establishing the node tags, a tool for establishing the relationships between the node tags and a tool for establishing space for holding the files under a node tag after the node tag is established; and the space for holding the files is called file space.

The graph module is further configured for displaying contents in the graph structure module as a graph structure, and adding the corresponding files to the file space under the node tag of the graph structure according to the information of the graph structure module in the tag recording module.

The file in the file space under the node tag has a corresponding relationship with the physical address where the file is stored.

Optionally, the file system contains the following features.

The graph structure is an unweighted graph structure, which is either an unweighted undirected graph or an unweighted directed graph.

The graph structure module is an array tag file, which describes composition and interrelationships of all the node tags that establish the unweighted graph structure in a certain order in a way that each row describes a relationship between a root node and branch nodes of one set of node tags.

Each row in the graph structure module has only one root node tag fixedly placed in one location, and the other tags are branch node tags arranged in a certain order.

Optionally, the file system contains the following features.

The graph structure is a weighted graph structure, which is either a weighted undirected graph or a weighted directed graph.

The graph structure module includes two array tag files. One of the two array tag files describes composition and interrelationships of all the node tags that establish the weighted graph structure in a certain order in a way that each row describes a relationship between a root node and branch nodes of one set of node tags. Each row in the graph structure module has only one root node tag fixedly placed in one location. The other tags are branch node tags arranged in a certain order. The other of the two array tag files is configured for recording weights between the node tags in the previous array tag file.

Optionally, the graph structure module includes a graph type tag for the graph structure, which is used to tag the type of the graph structure.

Optionally, the set of node tags that describes the relationship of a root node and branch nodes in the graph structure module includes a graph type tag for the set of the node tags, which is used to tag the type of the graph structure of the set of the node tags.

Optionally, the graph structure can be decomposed into several graph structures by decomposing the graph structure module and changing corresponding contents in the tag recording module.

Optionally, multiple graph structures can be merged into one graph structure by merging their graph structure modules together and changing corresponding contents in the tag recording module.

Alternatively, a method for constructing a graph structure of the file system through a user interface in the graph module includes the following steps.

building new node tags;

establishing relationships between the node tags;

storing the newly-built node tags and the relationships between the node tags as the graph structure module;

establishing a file space for holding files under each node tag as required respectively;

using the graph construction module to select a file corresponding to the node tag in the tag recording module and putting the file into the corresponding file space; and update the information of the graph structure module of the file corresponding to the node tag in the tag recording module.

It should be noted that in the above description of the graph structure module, all the expression manners targeted at the rows may also be applicable to columns. For example, “each row” is changed to “each column”. For consistency of expression, the following descriptions are still expressed with the rows as the target.

The present disclosure has the following advantages.

(1) The method for constructing the graph structure of the file system by using the tags as provided fulfills the requirements for diverse structural representations and multiple file structures within a file system.

(2) Due to the inclusion of all the necessary files and tags in the tag recording module, there is no need for graph traversal or opening of multi-level subdirectories to visualize the graph structure of the files. Consequently, the present disclosure provides a more intuitive and convenient file system structure.

### DESCRIPTION OF THE DRAWINGS

To more clearly describe the technical solutions in the embodiments of the present disclosure or in the prior art, the drawings required to be used will be simply presented below. Apparently, the drawings in the following description are merely the embodiments of the present disclosure, and for those ordinary skilled in the art, other drawings can also be obtained according to the provided drawings without contributing creative labor.

FIG. 1 is a schematic diagram of a method for constructing a graph structure of a file system according to embodiments of the present disclosure.

FIG. 2 is a schematic diagram of another method for constructing a graph structure of a file system according to embodiments of the present disclosure.

FIG. 3 is a graph structure of an unweighted directed graph according to embodiments of the present disclosure.

FIG. 4 is a graph structure of an unweighted directed graph with file space according to embodiments of the present disclosure.

FIG. 5 is another unweighted directed graph according to embodiments of the present disclosure.

FIG. 6 is an unweighted undirected graph according to embodiments of the present disclosure.

FIG. 7 is a graph structure of an unweighted undirected graph with file space according to embodiments of the present disclosure.

FIG. 8 is a weighted directed graph according to embodiments of the present disclosure.

FIG. 9 is a graph structure of a weighted directed graph with file space according to embodiments of the present disclosure.

FIG. 10 is a weighted undirected graph according to embodiments of the present disclosure.

FIG. 11 is a weighted undirected graph with file space according to embodiments of the present disclosure.

FIG. 12 is a graph structure constituted of three types of graph structures according to embodiments of the present disclosure.

FIG. 13 is a first graph structure after decomposition of an example in which one graph structure is decomposed into two graph structures, which is according to embodiments of the present disclosure.

FIG. 14 is a second graph structure after decomposition of an example in which one graph structure is decomposed into two graph structures according to embodiments of the present disclosure.

Reference Characters:
G1, one unweighted directed graph; G2, one unweighted undirected graph; G3, one weighted directed graph; G4, one weighted undirected graph; a1, a weight between two nodes; a2, a weight between two nodes; a3, a weight between two nodes; a4, a weight between two nodes; a5, a weight between two nodes; a6, a weight between two nodes.

### DETAILED DESCRIPTION OF PREFERRED EMBODIMENTS

The present disclosure will be further described in detail below in combination with embodiments and drawings, but implementations of the present disclosure are not limited to this. Based on the embodiments of the present disclosure, all other embodiments obtained by those ordinary skilled in the art without contributing creative labor belong to the protection scope of the present disclosure.

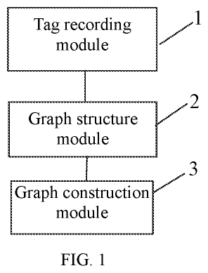

An embodiment of the present disclosure discloses a method for constructing a graph structure of a file system. As shown in FIG. 1, the method includes a tag recording module 1, a graph structure module 2 and a graph construction module 3.

The tag recording module 1 is configured for recording corresponding relationships between files and tags. The tag recording module 1 includes at least one row of recording.

Specifically, the file in the tag recording module 1 has a corresponding relationship with a physical address where the file is stored.

The file can be found, opened or edited by selecting the file in the tag recording module 1. For example, if the file comes from the file system with a directory structure, a physical address link of the file can be put in; and if the file comes from the file system without the directory structure “a file system”, a combination of the tag and a file name corresponding to a file control block (FCB) can be put in, so that the physical address of the file can be found by finding the FCB then the physical address.

The files can be tagged in Windows and Mac OS, namely the file systems with directories, and can also be tagged in “a file system”, namely the non-directory file system.

Using these technologies, a new tag recording module 1 is built to record these corresponding relationships when there are already a batch of tags corresponding to the files. This module may be a table, including two columns: one column is “File identification,” which can be a file name or other identification corresponding to the physical address where the file is stored. The other column is “Tag” which includes the tags of these files, as shown in Table 1. In subsequent operations, if the files or tags are found missing in the tag recording module 1, it is necessary to use the original file system to build new corresponding relationships between these files and tags and record them in the tag recording module 1.

TABLE 1

| | |
|---|---|
| File identification | Tag |

For example, there are tags A, B, C, D and E, as well as file 1, file 2, file 3 and file 4. The corresponding relationships between these files and tags are shown in Table 2.

TABLE 2

| File identification | Tag |
|---|---|
| File 1 | B |
| File 2 | C, E |
| File 3 | A, D, E |
| File 4 | D |

The graph structure module 2 is configured for describing tag composition and interrelationships at nodes where a graph structure is established. Meanwhile, the tag recording module 1 is also configured for recording information of the graph structure module 2. The information of the graph structure module 2 includes module identification of the graph structure module 2 and location information in the graph structure module 2 of a node tag used for selecting a file from the tag recording module 1.

In order to describe the graph structure, it is necessary to recall the definition of a graph: if there is an arbitrary before-and-after piecewise relationship R between elements of a data element set D, then this data structure B=(D, R) is referred to as a graph. A location where the data element is located is called a node. There are two types of graphs: undirected graphs and directed graphs. In an undirected graph, the edges connecting nodes have no direction, while in a directed graph, the edges connecting nodes have a specific direction.

In addition, in certain graphs, edges or arcs carry associated data information, which is referred to as a weight. Based on the presence or absence of weight, as well as the directionality, graphs can be categorized into four types: unweighted undirected graphs, unweighted directed graphs, weighted undirected graphs, and weighted directed graphs.

In the embodiment of the present disclosure, data elements of a graph are tags, and interrelationships between the tags are the before-and-after relationships. The graph structure module 2 is to determine which tags to be added to the graph structure and the before-and-after relationships between these tags.

Description of the graph structure can be represented by the storage structure of the graph. For example, the graph structure can be represented by an incidence matrix (also known as adjacency matrix): the matrix refers to representation by two arrays; a one-dimensional array stores information of node tags in the graph, and a two-dimensional array stores the relationships between the node tags in the graph.

The incidence matrix representation in detail: Let G(D, R) be a graph with n nodes d1, d2, . . . , dn. To store the graph G, a one-dimensional array D(1: n) of length n is used to store the information of each node in graph G. Additionally, a two-dimensional array R(1:n, 1:n) is used to store the association between nodes in the graph G. For each element R(i, j) (1≤i≤n, 1≤j≤n), its value can be either 1 or 0, depending on the association between nodes di and dj. If (di, dj) E R, then R(i, j)=1; otherwise, R(i, j)=0.

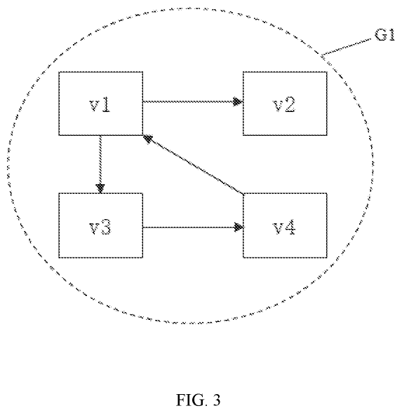

For example, to establish a graph structure G1 as shown in FIG. 3, which has four node tags v1, v2, v3 and v4. In this graph, v1 is a root node for v2 and v3, v3 is a root node for v4, and v4 is a root node for v1.

If Table 2 of the above example is continued and the node tags v1 to v4 assigned to the graph G1 are A, B, D and E respectively, the graph G1 can be represented by a one-dimensional array D1 and a two-dimensional array D2:

D1={A, B, D, E}

D2={{0,1,1,0}, {0,0,0,0}, {0,0,0,1}, {1,0,0,0}}

Where D2 represents relationships listed in Table 3 below: the horizontal title and the vertical title of the table are node tags, and the table has 4 rows and 4 columns except the titles. Since G1 is a directed graph, “1” only indicated at the root node. For example, a node tag A is the root node for node tags B and D, so corresponding values of the horizontal node tag A (row 1) to the vertical node tag B (column 2) and D (column 3) are all 1, whereas corresponding values of the horizontal node tag B (row 2) and D (row 3) to the vertical node tag A (row 3) are all 0.

TABLE 3

| | A | B | D | E |
|---|---|---|---|---|
| A | 0 | 1 | 1 | 0 |
| B | 0 | 0 | 0 | 0 |
| D | 0 | 0 | 0 | 1 |
| E | 1 | 0 | 0 | 0 |

In this way, D1 and D2 constitute the graph structure module 2 of G1.

The graph construction module 3 is configured for selecting corresponding files in the tag recording module 1 according to the node tag in the graph structure module 2, and recording the information of the graph structure module 2 corresponding to the file in the tag recording module 1, wherein the information of the graph structure module 2 includes module identification of the graph structure module 2 and the location information in the graph structure module 2 of the node tag used for selecting the files from the tag recording module 1.

This process is similar to the process of determining root directory and subdirectory names during building of a directory structure, as well as deciding which file to put in which directory and finally building the directory structure.

Specifically, locations of the node tags can be represented by rows and columns, which are started from 0. Recording the locations of node tags is to decide which file to select and which location to place the selected file when the file meets requirements of multiple node tags or when multiple files meet the requirements of the node tags. This location refers to a row number and a column number of the node tag used to select the file from the tag recording module 1 in the array of the graph structure module 2, which can also be omitted after some judgments: if it is judged that a file can only meet the requirement of one node tag and the node tag can only find the file, the location information of the node tag can be omitted; or, if it is judged that provision of only row or column information is enough to determine which file and a placement location thereof, the information can only include the row or column information.

Continuing with the above example, according to D1 in the graph structure module 2 of G1, it is found that D1 contains the node tags A, B, D and E. The corresponding files in Table 2 of the tag recording module 1 are to be found. The files found must have correspondences to the node tags of the destination location and can correspond to more node tags. For example, if file 3 needs to be put at the node tag A, file 3 must have a correspondence to node tag A. Based on this principle, it is possible to put file 3 at the node tag A, file 1 at the node tag B, file 4 at the node tag D and file 2 at the node tag E. Then add a column to Table 2: “Information of the graph structure module”, and fill the choices to get Table 4.

TABLE 4

| File | | Information of the |
|---|---|---|
| identification | Tag | graph structure module |
| File 1 | B | D1 (1) |
| File 2 | C, E | D1 (3) |
| File 3 | A, D, E | D1 (0) |
| File 4 | D | D1 (2) |

Specifically, since D1 is known to belong to the graph G1 and D1 is the module identification of the graph G1 in Table 4, G1D1 can also be directly used as the module identification. The module identification here is also called a graph structure identification.

In this way, the graph structure of the file system of the graph G1 is constructed; and a user can check or display the graph structure by D1, D2 and Table 4.

Further, in Table 4, there is no doubt that the tags corresponding to file 1 only corresponds to the location of the node tag B and only one file can be found when files are searched with the tag B, so the location information corresponding to file 1 can be omitted.

Only file 3 meets the requirements of the node tag A, but it also meets the requirements of the node tag D and the node tag E, so it is necessary to fill in location information; and file 4 can only be placed at the node tag D, but multiple files can be found by the tag D, so location information is needed. Hence, only the information of the graph structure module of file 1 in Table 4 can be simplified to D1.

In addition, no file or multiple files can be put at one node tag location. For example, file 3 can be arranged at the node tag D, if so, the information of the graph structure module corresponding to file 3 in Table 4 will be changed to D1 (2).

If the information of the graph structure module of a file is empty, the file is not placed on the graph structure.

The graph structure of the file system established in the embodiment of the present disclosure is different from the directory structure. When a file and related files are searched, the graph structure and other files in this graph structure can be found just by searching this file in the tag recording module 1, without traversal of the graph structure. For example, to find file 4, the file can be found in Table 4; then the graph structures D1 and G1 thereof are found; and then other files in D1: file 1, file 2 and file 3 are found, which are the related files of file 4. Contrastively, the searching of files in the directory structure usually needs to traverse all subdirectories, so the graph structure of the embodiment of the present disclosure can search files faster than the directory structure.

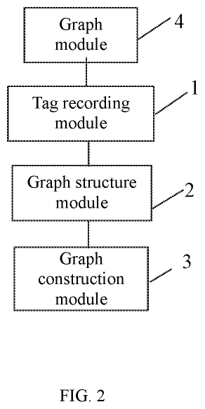

Further, the embodiment of the present disclosure discloses a construction method of a graph structure of a file system. As shown in FIG. 2, the method includes a graph module 4, a tag recording module 1, a graph structure module 2 and a graph construction module 3.

The graph module 4 is configured for establishing and/or displaying a graph structure containing node tags and relationships between the node tags;

The graph module 4 has a user interface; the user interface includes a tool for establishing the node tags, a tool for establishing the relationships between the node tags and a tool for establishing space for holding the files under a node tag after the node tag is established, wherein the graph module 4 is further configured for displaying contents in the graph structure module 2 as a graph structure, and adding the corresponding files to the file space under the node tag of the graph structure according to the information of the graph structure module for the graph structure module 2 in the tag recording module 1.

Specifically, a new graph structure can be built in the graph module 4. The newly-built graph structure can be stored as the graph structure module 2. The information of the graph structure module in the tag recording module 1 can be updated for later calling. The graph module 4 can also call up an established graph structure module 2 and display the graph structure in combination with the contents of the tag recording module 1.

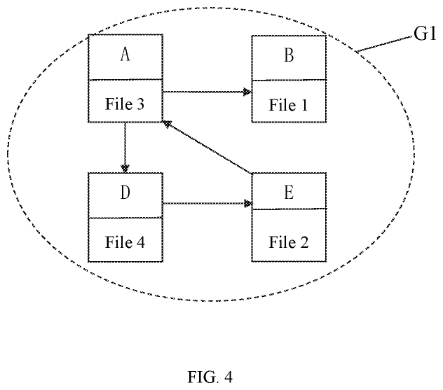

For example, a process of constructing the graph structure of the file system of the graph G1 style as shown in FIG. 4 through the user interface may include the following 5 steps:

1. Building four new node tags v1, v2, v3 and v4, wherein these tags can be tags that are already in the tag recording module 1, otherwise, these tags need to be newly built by using the original file system and recorded in the tag recording module 1;

Note: continuing with the previous example, the node tags v1, v2, v3 and v4 here correspond to node tags A, B, D and E in FIG. 4 respectively.

2. Establishing relationships between the node tags. In this example, v1 is the root node for v2 and v3; v3 is the root node for v4; and v4 is the root node for v1;

3. Storing the newly-built node tags and interrelationships thereof as the graph structure module; Specifically, the newly-built four node tags v1, v2, v3 and v4 are stored as a file similar to the graph structure module D1 in the previous example, and the relationships thereof are stored as a file similar to the graph structure module D2 in the previous example;

4. Establishing file spaces for holding files under each tag of the node respectively as required;

5. The graph structure module 3 is configured to select files corresponding to each node tag in the tag recording module 1, and putting these files into the corresponding file spaces, and then update the information of the graph structure module 2 of the files corresponding to each node tag in the tag recording module 1.

On the other hand, when an existing graph structure module file 2 is called up following the previous example, the first step of the flow can be completed according to the graph structure module D1; the second step can be completed according to the graph structure module D2; skip the third step as it is not needed; and then the fourth and fifth steps of the flow are completed according to the information of the graph structure module corresponding to the module identification D1 of the graph G1 in Table 4 of the tag recording module 1, thereby establishing the graph structure including the node tags and corresponding files under node tags, as shown in FIG. 4.

Specifically, the files in the tag recording module 1 and the files in the graph structure file space have corresponding relationships with physical addresses where the files are stored.

Specifically, the files in Tables 2 to 4 and the files in FIG. 4 can directly correspond to the physical addresses where the files are stored, so that clicking on the files can directly open the files.

Further, when the graph structure is an unweighted graph structure, the structure is either an unweighted undirected graph or an unweighted directed graph. The graph structure module 2 is an array tag file that describes the composition and interrelationship of all node tags that build the unweighted graph structure in the order of top-down left-to-right with each line describing the root node and branch node relationship of one set of node tags of the graph where the one set only includes one root node tag.

It should be noted that for undirected graphs, including unweighted undirected graphs and weighted undirected graphs types, there is no directional relationship between any two node tags, the root node is actually a starting node of a relationship line segment, and the branch node is an ending node of the relationship line segment. The reason why the starting node and the ending node are distinguished is only to describe starting and ending of a line segment. The starting node (or root node) and the ending node (or branch node) can be interchanged under the condition of ensuring a same connection relationship. For example, a connecting line between the two node tags A and B can regard A as the starting node or root node, or regard B as the starting node or root node. To keep it concise, while describing it together with a directed graph, the undirected graph is still described by root and branch nodes subsequently.

Specifically, the root node tag can be fixedly placed in the first location in each row, and the rest of the tags are branch node tags arranged in left-to-right order. When the graph structure module 2 is a two-dimensional array tag file, each row can start from describing the relationship of a root node tag and its branch node tags, or checking whether a branch node tag from left to right appearing in a previous row from top to down is a root tag and the relationship with its branch node tags has been described, and if not describing it in the row.

Specifically, in the above example, if G1 only contains three node tags, A, B and D, and does not include the node tag E, it can be described by a one-dimensional array tag file D3: D3={A, D, B}.

The first digit “A” in D3 is the root node tag, and the other two digits are the two branch node tags “D” and “B” of “A” from left to right. D3 contains not only the three node tags A, B and D needed in the graph, but also the description of the relationships between these node tags.

Specifically, when G1 contains the node tag E in the above example, the graph structure module 2 can be described by a two-dimensional array tag file D4: the first row first describes the case where A is the root node tag and D and B are branch node tags, so there is {A, D, B}; the second row first checks whether the first branch node tag D in the previous row is a root node tag, and the result is that it is, so there is {D, E}; the third row then checks whether the second branch node tag E in the previous row is a root node, and the result is that it is also, so there is {E, A}; and at last D4={{A, D, B}, {D, E}, {E, A}}.

D4 also contains both the node tags needed in the graph and the description of the relationships between these node tags. There can be multiple locations of a node tag in D4. For example, the location of node tag A can be D4 (0,0) or D4 (2,1).

According to the elements in the graph structure module D4 of G1, duplicate items are deleted, and it is found the graph structure module contains node tags A, B, D and E. The corresponding files are found in Table 2 of the tag recording module 1. The found files must have correspondences to the node tags of the destination location and can correspond to more node tags. For example, file 3 is placed at the node tag A; file 1 is placed at the node tag B; file 4 is placed at the node tag D; and file 2 is placed at the node tag E. Then, these are filled in Table 2 to obtain Table 5.

TABLE 5

| File | | Information of |
|---|---|---|
| identification | Tag | graph structure module |
| File 1 | B | D4 (0, 2) |
| File 2 | C, E | D4 (1, 1) |
| File 3 | A, D, E | D4 (0, 0) |
| File 4 | D | D4 (0, 1) |

Since D4 is known to belong to the graph G1, and D4 is the module identification of the graph G1 in Table 5, G1D4 can also be directly used as the module identification.

The case of establishing a graph structure in the graph module 4 containing node tags and the corresponding files under node tags based on D4 in the graph structure module 2 and the tag recording module Table 5, is the same as the case when the previous graph structure module 2 is D1 and D2, both of the graph structures are FIG. 4. D4 of the embodiment of the present disclosure substantially replaces D1 and D2 of the previous graph structure module 2.

Compared with the graph storage mode of an incidence matrix, the embodiment of the present disclosure uses one array instead of two arrays in the incidence matrix to store the graph structure, so the present disclosure has the advantages of reducing complexity and saving storage space.

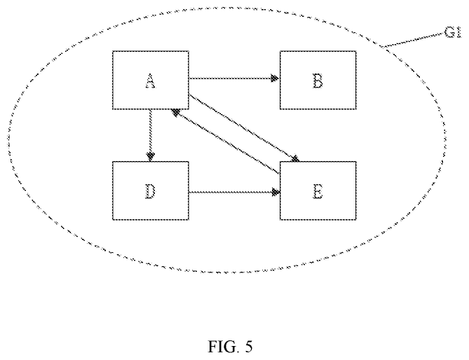

It should be noted that the embodiment of the present disclosure can express various special types of graph structures. For example, FIG. 5 shows a graph with multiple relationships between nodes. It shows mutual root node and branching node relationships between A and E, and a graph structure module 2 thereof is: D5={{A, D, B}, {D, E}, {E, A}, {A, E}}.

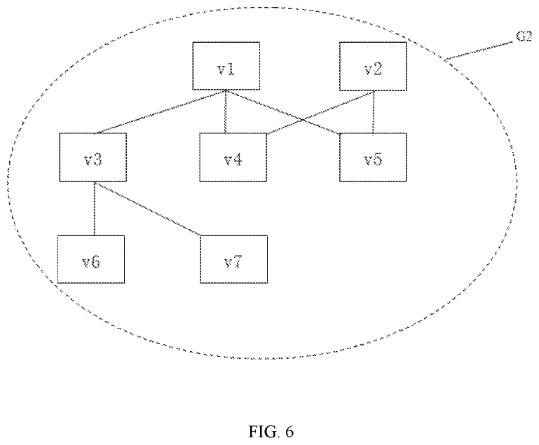

For another example, the graph structure of the file system of an unweighted undirected graph G2 is to be established, as shown in FIG. 6, which contains seven node tags v1, v2, v3, . . . v7. The relationships between them are: v1 is the root node for v3, v4 and v5; v3 is the root node for v6 and v7; and v2 is the root node for v4 and v5.

For example, 10 files are prepared to be put into G2, and they correspond to 15 tags A, B, C, . . . O, as shown in Table 6. However, at this moment, the content of the information of the graph structure module has not been filled yet.

TABLE 6

| File | | Information of the |
|---|---|---|
| identification | Tag | graph structure module |
| File 1 | B | D6 (0, 2) |
| File 2 | B, C, K | D6 (0, 2) |
| File 3 | A, J, E | D6 (0, 0) |
| File 4 | D | D6 (2, 0) |
| File 5 | A, O | D6 (0, 0) |
| File 6 | F, D, B | D6 (1, 1) |
| File 7 | H, I | D6 (1, 2) |
| File 8 | L, M, G | D6 (1, 0) |
| File 9 | H, N | D6 (2, 2) |
| File 10 | L, M | D6 (1, 0) |

If the node tags v1 to v7 in the graph G2 are tags A, D, L, B, N, F and H respectively, the graph structure module of G2 can be described by a two-dimensional array tag file D6:

D6={{A, L, B, N}, {L, F, H}, {D, B, N}}

Wherein D6(0,0) for “A” is a root node tag, similarly D6(1,0) for “L” and D6(2,0) for “D” are root node tags, and the rest of the locations are branch node tags.

According to elements in the graph structure module D6 of G2, after duplicated items are deleted, the module is found to contain node tags A, L, B, N, F, H, D. The corresponding files in the tag recording module Table 6 are found by the rule that the files must have correspondences to the node tags of the destination location and may correspond to more node tags. For example, file 3 and file 5 are placed at the node tag A; file 1 and file 2 are placed at the node tag B; file 4 is placed at the node tag D; the file 7 is placed at the node tag H; the file 8 and file 10 are placed at the node tag L; the file 9 is placed at the node tag N; and then fill these choices into the column of the information of the graph structure module in Table 6.

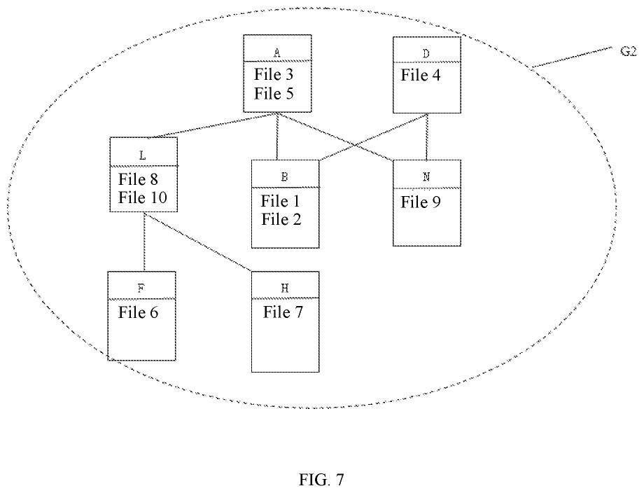

When the graph structure is displayed, an unweighted undirected graph is established in graph module 4 according to D6, and then the graph structure with files under node tags is obtained according to Table 6, as shown in FIG. 7. For the convenience of operation, all the module files of G2 can also be established in the graph module 4 through the user interface, and at last, the graph structure shown in FIG. 7 can be displayed.

It is not difficult to find that G2 is a graph structure similar to the directory structure. If the structure is represented as a directory structure, the node tags v1 and v2 in G2 must be in two side-by-side subdirectories, so there must be two copies of the files at the node tags v4 and v5 shared between them, that is, there is one copy in each of the two subdirectories, hence, the two subdirectories must be both opened to see that the files are shared between them, which is quite unintuitive.

Further, when the graph structure is a weighted graph structure, it is either a weighted undirected graph or a weighted directed graph. The graph structure module 2 contains two array tag files. One of the two array tag files can describe the composition and relationships of all the node tags that establish the weighted graph structure in a way that each row describes the relationships between the root node and the branch nodes of one set of node tags in the order from top to bottom and from left to right. The other of the two array tag files is used to record weights between the node tags in the previous array tag file.

Similar to the description of the above-mentioned unweighted undirected graph, because there is no directional relationship between any two node tags in the weighted undirected graph, the root node is actually the starting node of the relationship line segment. Furthermore, the branch node is the ending node of the relationship line segment. The reason why the starting node and the ending node are distinguished is only to describe beginning and ending of a line segment.

Specifically, the root node tag of each row of the array tag file describing the relationship between node tags can be fixedly placed in the first place, and the branch nodes can be placed in other locations in the order of left-to-right. When the file is a two-dimensional array tag file, each row can start from describing the relationship of a root node tag and its branch node tags, or checking whether a branch node tag from left to right in a previous row from top to down is a root node tag and the relationship with its branch node tags has been described, and if not describing it in the row.

Specifically, when the graph structure module has two one-dimensional array tag files, the two one-dimensional array tag files can be merged into a two-dimensional array tag file. Each row corresponds to an original one-dimensional array tag file. Similarly, when the graph structure module includes two two-dimensional array tag files, the two two-dimensional array tag files can also be merged into one two-dimensional array tag file. The number of rows is the sum of the original two two-dimensional array tag files. The upper and lower parts respectively correspond to the original two-dimensional array tag file. In the following, two one-dimensional array tag files or two two-dimensional array tag files are still used for discussion.

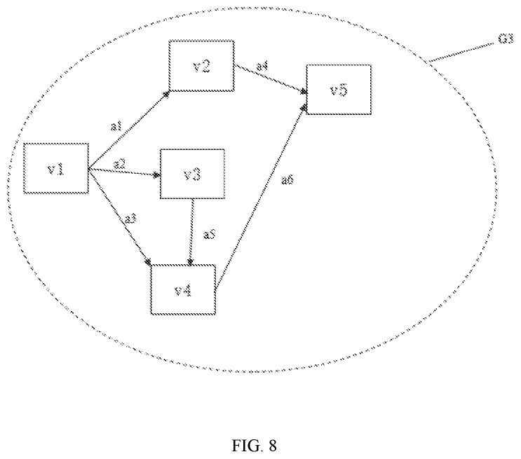

For example, to build a new weighted directed graph G3, as shown in FIG. 8, the graph contains 5 node tags v1, v2, . . . v5 and their weighted relationships, which are represented by connecting lines a1, a2, . . . a6 between the 5 nodes.

If G3 is a project progress schedule, it is established to control the influence of different activities on the schedule in time. These 6 connecting lines are 6 activities, and these 5 node tags represent 5 events. Each event indicates that the activity before it has been completed and the activity after it can be started. For example, v1 means the beginning of the whole project, and v5 means the end of the whole project. The number related to each activity is the time required to execute the activity. For example, the numbers of days required for each activity are: 6 days for a1, 4 days for a2, 1 day for a3, 3 days for a4, 6 days for a5, and 8 days for a6. Records of previously completed activities and files corresponding to the event should be placed at each event. For example, these files are file 1, file 2, . . . file 9, as shown in Table 7. However, at this moment, the content of the information of the graph structure module is not filled up yet. The files in Table 7 can correspond to other node tags besides v1, v2, . . . v5. For example, file 1 corresponds to both v1 and Li tags, the Li tag indicates that this file is in the charge of Li; the file 8 corresponds to both v2 and log 3 tags, and the log 3 tag indicates that it records the activities of a3.

TABLE 7

| File | | Information of the |
|---|---|---|
| identification | Tag | graph structure module |
| File 1 | v1, Li | D7 |
| File 2 | v2, Li | D7(0, 1) |
| File 3 | v3, Wang | D7(0, 2) |
| File 4 | v4, Wang, log5 | D7(0, 3) |
| File 5 | v5, Wang | D7(1, 1) |
| File 6 | v2, log1 | D7(0, 1) |
| File 7 | v3, log2 | D7(0, 2) |
| File 8 | v4, log3 | D7(0, 3) |
| File 9 | v5, log4, log6 | D7(1, 1) |

To establish its graph structure module 2, it is necessary to establish two two-dimensional array tag files. First, a file D7 describing the relationship between node tags is established. The specific steps are as follows:

1) For the first row, first describing a situation that v1 is a root node, v2, v3 and v4 are branch nodes, so there is {v1, v2, v3, v4};

2) For the next three rows, checking whether each of the branch nodes v2, v3 and v4 in the previous row is a root node in order, wherein the result is yes for all, so there is {v2, v5}, {v3, v4} and {v4, v5};

3) Confirming all the branch nodes in the previous row are checked, and finally D7={{v1, v2, v3, v4}, {v2, v5}, {v3, v4}, {v4, v5}}.

Then a two-dimensional array tag file D8 describing weights between node tags is established, the specific steps are as follows:

1) Checking weights between the root node tags in all the rows and branch nodes in D7, for example, the weights between the first row v1 and its branch nodes v2, v3 and v4 in D7, so there is {6,4,1};

2) Confirming all the nodes in D7 are checked, and finally D8={{6,4,1}, {3}, {6}, {8}}.

According to the elements in the graph structure module D7 of G3, duplicate items are deleted. It is found that it contains node tags v1, v2, . . . v5. The corresponding files in the tag recording module Table 7 are found out; and then these choices are filled into the column of information of the graph structure module in Table 7.

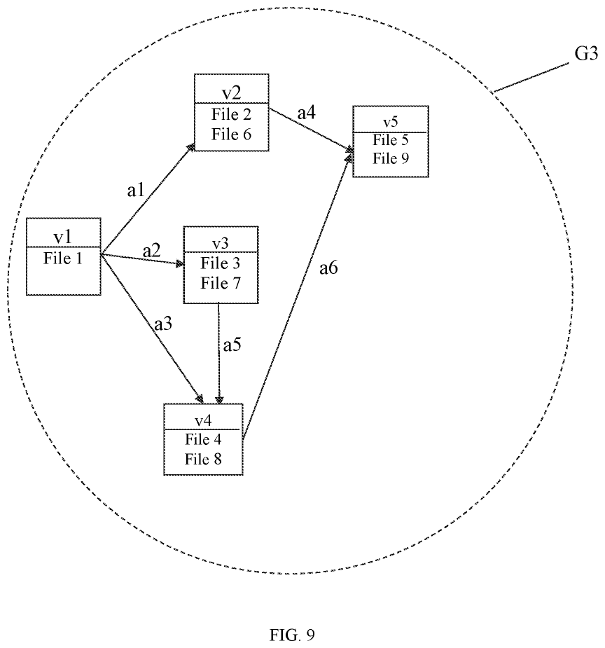

When the graph structure is displayed, in the graph module 4, a weighted directed graph is established according to D7 and D8 in the graph structure module 2, and then a graph structure including node tags and corresponding files under node tags is established according to Table 7 in tag recording module 1, as shown in FIG. 9.

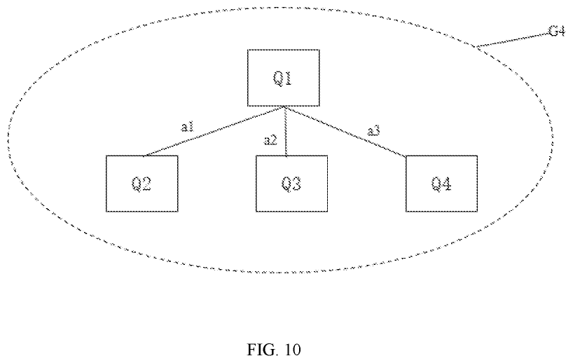

For another example, an embodiment of a weighted undirected graph in the embodiment of the present disclosure is a close relationship group graph G4 in QQ, as shown in FIG. 10. Each contact in QQ has its own related files. A weight of a close relationship between contacts can be set higher, and a weight of an unfamiliar relationship can be set lower. One of the advantages of this is that when publishing messages, it is possible to select audiences according to the weight. For example, there are four contacts Q1, Q2, Q3 and Q4 in FIG. 10. When Q1 is the root node tag, its branch node tags are Q2, Q3 and Q4. The weights between Q1 and them are a1, a2 and a3, respectively, and a1=5, a2=1 and a3=3, wherein the weight is 5 indicating that a relationship is close, the weight is 1 indicating that the relationship is relatively distant, and the weight is 3 indicating that the relationship is common.

For example, each contact has only one file and the file corresponds to one tag as shown in Table 8 of the tag recording module 1, but at this moment, the content of information of the graph structure module has not been filled up yet:

TABLE 8

| File | | Information of the |
|---|---|---|
| identification | Tag | graph structure module |
| File 1 | Q1 | D8 |
| File 2 | Q2 | D8 |
| File 3 | Q3 | D8 |
| File 4 | Q4 | D8 |

Then, the graph structure module 2 of G4 can be established as D8={Q1, Q2, Q3, Q4}, and the information of D8 can be directly filled into the information of the graph structure module column in Table 8.

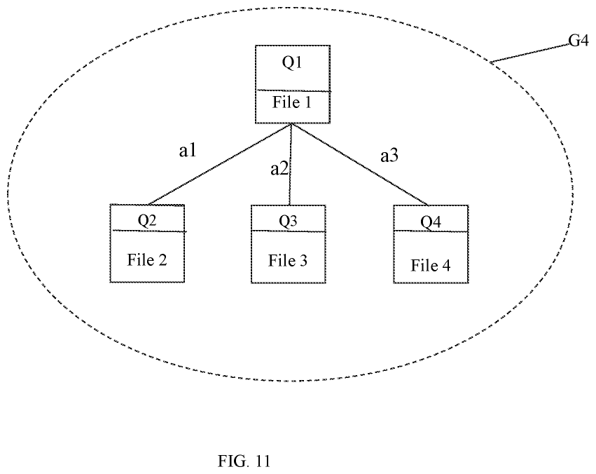

For being displayed, the weighted undirected graph is established in the graph module 4 according to D8 and the information of the graph structure module in Table 8, then it is displayed as shown in FIG. 11.

The embodiment of the present disclosure can use different tools for establishing node tag relationships when establishing the graph structure in the graph module 4 to indicate what the graph structure is a type of. For example, connecting two node tags with an unweighted straight line without arrow indicates that they have an unweighted undirected relationship; connecting them with an unweighted straight line with an arrow indicates that they have an unweighted directed relationship, and the arrow points from the root node to the direction of the branch node; connecting them with a weighted straight line without arrow indicates that they have a weighted undirected relationship; and connecting them with a weighted straight line with an arrow indicates that they have a weighted directed relationship, and the arrow points from the root node to the branch node.

Further, the graph structure module 2 includes a graph type tag of the graph structure, which is used to indicate a type of the graph structure.

Specifically, the graph type tag can be represented by the following tags:
0: unweighted undirected graph, which is default setting of the graph type tag, that is, the graph structure is an unweighted undirected graph when there is no graph type tag in the graph structure module 2;
1: unweighted directed graph;
2: weighted undirected graph;
3: weighted directed graph.

The graph type tag of the graph structure can be fixed at the first location in the first row of the array tag file describing the relationship between the root node and the branch nodes of the node tag in the graph structure module 2. In this case, the root node tag location in the first row in the previous example can be moved back by one location to the second location in the first row, and the location information of the graph structure module corresponding to the node tag in the corresponding tag recording module 1 needs to be changed. For example:

The graph structure module D4 of the unweighted undirected graph G1 can be changed to {{1, A, D, B}, {D, E}, {E, A}}, where 1 indicates that this is an unweighted undirected graph, the location information of the tag Ain the tag recording module 1 should be changed from D4(0,0) to D4(0,1), the location information of the tag B should be changed from D4(0,2) to D4(0,3), the location information of the tag D should be changed from D4(0,1) to D4(0,2), and Table 5 is changed to Table 9.

TABLE 9

| File | | Information of the |
|---|---|---|
| identification | Tag | graph structure module |
| File 1 | B | D4(0, 3) |
| File 2 | C, E | D4(1, 1) |
| File 3 | A, D, E | D4(0, 1) |
| File 4 | D | D4(0, 2) |

In the graph module 4, a new graph structure can be established or an established graph structure file stored as a file can be called up and displayed. After the graph structure module 2 containing the graph type tag, it completely describes a graph structure, so the file of the graph structure module 2 can be called up in the graph module 4 to establish a graph structure, followed by finding the corresponding files in the tag recording module 1 and then displaying the complete graph structure.

Further, a graph structure can also be constituted of different types of graph structures. A set of node tags which describing one relationship between a root node and branch nodes in graph structure module 2 can include a graph type tag of the graph structure, while other sets of node tags containing different graph type tags. If this is implemented in one set of a graph structure, every set of node tags should contain its own graph type tag, the ones without the graph type tag will be considered as default unweighted undirected graphs.

For example, if the graph structure module D4 of the unweighted directed graph G1 is changed to

D40={{1,A,D,B},{2,D,E},{E,A}}

Then G1 is no longer all unweighted directed graphs, but only the first set {1, A, D, B} is an unweighted directed graph. The second set {2, D, E} is a weighted undirected graph, and the third set{E, A} is an unweighted undirected graph. Because the second group is a weighted graph, it is necessary to add an array tag file, in which a special tag can be used to represent the weight of the unweighted graph. Assuming that the weight between D and E is a1 and a1=5, and the special tag of the unweighted graph is −1, the added array tag file is:

D41={{−1},{5},{−1}}

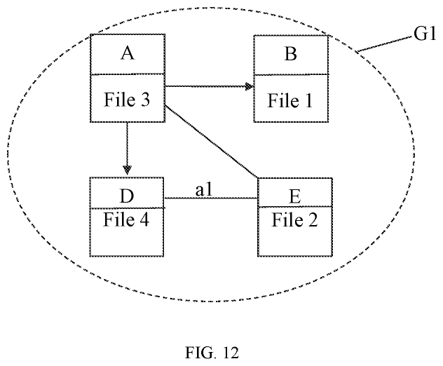

Now D40 and D41 together form the graph structure module 2 of G1, and the corresponding graph structure is shown in FIG. 12.

Further, a graph structure can be decomposed into multiple graph structures by decomposing the graph structure module 2, and the corresponding contents in the tag recording module 1 need to be updated accordingly.

For example, the graph structure module of the graph G2, namely D6={{A, L, B, N}, {L, F, H}, {D, B, N}} can be decomposed into:

D60={{A,L,B,N},{L,F,H}}

D61={D,B,N}

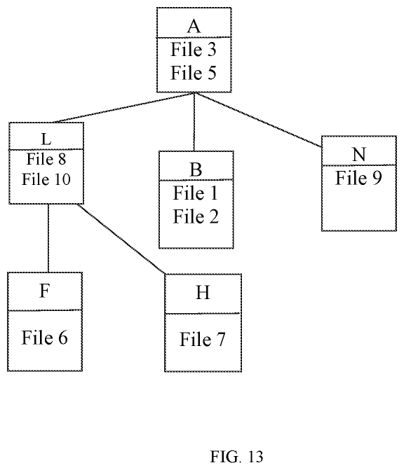

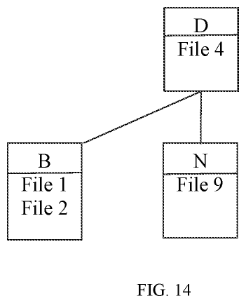

Table 6 of the corresponding tag recording module 1 becomes Table 10, and the corresponding graph structures are shown in FIG. 13 and FIG. 14. FIG. 13 corresponds to the graph structure module D60, and FIG. 14 corresponds to the graph structure module D61.

TABLE 10

| File | | Information of the |
|---|---|---|
| identification | Tag | graph structure module |
| File 1 | B | D60(0, 2), D61 |
| File 2 | B, C, K | D60(0, 2), D61 |
| File 3 | A, J, E | D60(0, 0) |
| File 4 | D | D61 |
| File 5 | A, O | D60(0, 0) |
| File 6 | F, D, B | D60(1, 1) |
| File 7 | H, I | D60(1, 2) |
| File 8 | L, M, G | D60(1, 0) |
| File 9 | H, N | D60(2, 2), D61 |
| File 10 | L, M | D60(1, 0) |

Further, multiple graph structures can be merged into one graph structure by merging the graph structure module 2, and updating the corresponding contents in the tag recording module 1. This theory is the same as that of the above graph structure decomposition but doing the opposite operations, which will not be illustrated with examples.

The above are only the preferred embodiments of the present disclosure, and the protection scope of the present disclosure is not limited to the above embodiments. All technical solutions under the idea of the present disclosure belong to the protection scope of the present disclosure. It should be pointed out that for those ordinary skilled in the art, several improvements and modifications without departing from the principles of the present disclosure shall also be regarded as the protection scope of the present disclosure.

What is claimed is:

1. A file system for constructing a graph structure, comprising:
a tag recording module, configured for recording corresponding relationships between files and tags; wherein the tag recording module comprises at least one row of recording;
a graph structure module, configured for describing tag composition and interrelationships at nodes where a graph structure is established, wherein the tags at the nodes of the graph structure are called node tags, and the tag recording module is also configured for recording information of the graph structure module; and
a graph construction module, configured for selecting a corresponding file in the tag recording module according to a node tag in the graph structure module, and recording the information of the graph structure module corresponding to the file in the tag recording module;
wherein the information of the graph structure module comprises module identification of the graph structure module and location information in the graph structure module of the node tag configured for selecting the file from the tag recording module;
wherein the file in the tag recording module has a corresponding relationship with a physical address where the file is stored.

2. The file system according to claim 1, further comprising:
a graph module, configured for establishing and/or displaying the graph structure comprising the node tags and relationships between the node tags;
wherein the graph module has a user interface; the user interface comprises a tool for establishing the node tags, a tool for establishing the relationships between the node tags, and a tool for establishing space for holding the files under the node tag after the node tag is established; and the space for holding the files is called file space;
wherein the graph module is further configured for displaying contents in the graph structure module as the graph structure, and adding the corresponding files to the file space under the node tag of the graph structure according to the information of the graph structure module in the tag recording module;
wherein the file in the file space under the node tag has a corresponding relationship with the physical address where the file is stored.

3. The file system according to claim 1, wherein
the graph structure is an unweighted graph structure; the unweighted graph structure is either an unweighted undirected graph or an unweighted directed graph;
the graph structure module is an array tag file, which describes composition and interrelationships of all the node tags that establish the unweighted graph structure in a certain order in a way that each row describes a relationship between a root node and branch nodes of one set of node tags;
each row in the graph structure module has only one root node tag fixedly placed in one location; and the other tags are branch node tags arranged in a certain order.

4. The file system according to claim 1, wherein the graph structure is a weighted graph structure; the weighted graph structure is either a weighted undirected graph or a weighted directed graph;
the graph structure module comprises two array tag files, wherein one of the two array tag files is configured for describing composition and interrelationships of all the node tags that establish the weighted graph structure in an order in a way that each row describes a relationship between a root node and branch nodes of one set of node tags; each row in the graph structure module has only one root node tag fixedly placed in one location; the other tags are branch node tags arranged in a certain order; the other of the two array tag files is used for recording weights between the node tags in the previous array tag file.

5. The file system according to claim 3, wherein the graph structure module comprises a graph type tag of the graph structure, which is used to tag the type of the graph structure.

6. The file system according to claim 4, wherein the graph structure module comprises a graph type tag of the graph structure, which is used to tag the type of the graph structure.

7. The file system according to claim 3, wherein the set of node tags describing the relationship of a root node tag and branch node tags in the graph structure module comprise a graph type tag for the set of the node tags, which is used to tag the type of the graph structure of the set of the node tags.

8. The file system according to claim 4, wherein the set of node tags describing the relationship of a root node tag and branch node tags in the graph structure module comprise a graph type tag for the set of the node tags, which is used to tag the type of the graph structure of the set of the node tags.

9. The file system according to claim 1, wherein the graph structure can be decomposed into several graph structures by decomposing the graph structure module and changing corresponding contents in the tag recording module.

10. The file system according to claim 1, wherein the multiple graph structures can be merged into one graph structure by merging the graph structure modules of the multiple graph structures together and changing corresponding contents in the tag recording module.

11. A method for constructing a graph structure of a file system of claim 2, comprising the following steps:
building new node tags;
establishing relationships between the node tags;
storing the newly-built node tags and the relationships between the node tags as the graph structure module;
establishing file space for holding files under each node tag as required respectively;
using the graph construction module to select a file corresponding to the node tag in the tag recording module and putting the file into the corresponding file space, and update the information of the graph structure module of the file corresponding to the node tag in the tag recording module.
